(19) United States
(12) Patent Application Publication
(10) Pub. No.: US 2026/0341202 A1
(43) Pub. Date: Oct. 29, 2026

(54) LIGHT EMITTING DISPLAY APPARATUS

(71) Applicant: LG Display Co., Ltd., Seoul (KR)

(72) Inventor: YongWon Jo, Paju-si (KR)

(21) Appl. No.: 19/661,079

(22) Filed: Apr. 28, 2026

(30) Foreign Application Priority Data
Apr. 29, 2025 (KR) 10-2025-0056009

(51) Int. Cl. G09G 3/32

(52) U.S. Cl. CPC G09G 3/32; G09G 2300/0452; G09G 2300/0819; G09G 2300/0852; G09G 2300/0861; G09G 2310/0286; G09G 2310/08; G09G 2330/021

(57) ABSTRACT

A light emitting display apparatus includes a light emitting display panel in which a first gate line and a first scan line extend along a first direction, and a data line extends along a second direction different from the first direction. A gate driving circuit is provided in a non-display area of the light emitting display panel and supplies driving signals to the first gate line and the first scan line. Sub-pixels that output light of the same color are arranged in a first row along the first direction. The sub-pixels arranged along the first direction are connected to the first gate line and the first scan line, and the first scan line is connected to a second scan line arranged in a second row adjacent to the first row.

### CROSS-REFERENCE TO RELATED APPLICATIONS

Pursuant to 35 U.S.C. § 119(a), this application claims the benefit of an earlier filing date and right of priority to Korean Patent Application No. 10-2025-0056009 filed on Apr. 29, 2025, the content of which is hereby incorporated by reference in its entirety.

### TECHNICAL FIELD

The present disclosure relates to a light emitting display apparatus.

### BACKGROUND

Light emitting display apparatus can be implemented to display information and images in various electronic products such as televisions, monitors, notebook computers, smart phones, tablet computers, electronic pads, wearable devices, watch phones, portable information devices, navigation devices, or vehicle control display devices, etc.

As the size of the light emitting display apparatus increases for the user's convenience, the number of data lines is increasing, and accordingly, the number of data drivers is increasing.

In addition, as the number of data drivers increases, the manufacturing cost of light emitting display apparatus increases, and the manufacturing process of light emitting display apparatus becomes complicated.

### SUMMARY

According to an aspect of the present disclosure, a light emitting display apparatus includes a light emitting display panel in which a first gate line and a first scan line extend along a first direction, and a data line extends along a second direction different from the first direction and a gate driving circuit provided in a non-display area of the light emitting display panel and supplying driving signals to the first gate line and the first scan line, wherein sub-pixels that output light of the same color are provided in a first row along the first direction, the sub-pixels provided along the first direction are connected to the first gate line and the first scan line, and the first scan line is connected to a second scan line provided in a second row adjacent to the first row.

It is to be understood that both the foregoing general description and the following detailed description of the present disclosure are examples and explanatory and are intended to provide further explanation of the disclosure as claimed.

### BRIEF DESCRIPTION OF THE DRAWINGS

FIG. 1 is an example diagram illustrating a configuration of a light emitting display apparatus according to an implementation of the present disclosure;

FIG. 2 is an example diagram illustrating a structure of a sub-pixel applied to a light emitting display apparatus according to an implementation of the present disclosure;

FIG. 3 is an example diagram illustrating a structure of a control circuit applied to a light emitting display apparatus according to an implementation of the present disclosure;

FIG. 4 is an example diagram illustrating a structure of a light emitting display panel applied to a light emitting display apparatus according to an implementation of the present disclosure;

FIG. 5 is a waveform diagram illustrating a TRD data enable signal applied to a light emitting display apparatus according to an implementation of the present disclosure;

FIG. 6 is an example diagram illustrating structures of a light emitting display panel and a gate driving circuit applied to a light emitting display apparatus according to an implementation of the present disclosure;

FIG. 7 is waveform diagrams of signals applied to a light emitting display apparatus according to an implementation of the present disclosure; and

FIGS. 8 to 10 are example diagrams illustrating driving methods of a pixel driving circuit applied to a light emitting display apparatus according to an implementation of the present disclosure.

### DETAILED DESCRIPTION

Implementations of the present disclosure can provide a light emitting display apparatus with a reduced number of data drivers in the light emitting display panel without loss of resolution, thereby reducing the manufacturing cost and simplifying the manufacturing process of the light emitting display apparatus.

Implementations of the present disclosure can provide a light emitting display apparatus in which sub-pixels of the same color are provided along a gate line and scan lines provided in adjacent rows are connected.

According to implementations of the present disclosure, the number of stages corresponding to a unit pixel can be reduced, without loss of resolution. Accordingly, a light emitting display panel with a reduced non-display area can be provided.

Additional advantages and features of the disclosure will be set forth in part in the description which follows and in part will become apparent to those having ordinary skill in the art upon examination of the following or can be learned from practice of the disclosure. The objectives and other advantages of the disclosure can be realized and attained by the structure particularly pointed out in the written description as well as the appended drawings.

Advantages and features of the present disclosure, and implementation methods thereof will be clarified through following implementations described with reference to the accompanying drawings. The present disclosure can, however, be embodied in different forms and should not be construed as limited to the implementations set forth herein. Rather, these implementations are provided so that this disclosure will be thorough and complete, and will fully convey the scope of the present disclosure to those skilled in the art.

A shape, a size, a ratio, an angle, and a number disclosed in the drawings for describing implementations of the present disclosure are merely an example, and thus, the present disclosure is not limited to the illustrated details. Like reference numerals refer to like elements throughout. In the following description, when the detailed description of the relevant known function or configuration is determined to unnecessarily obscure the important point of the present disclosure, the detailed description will be omitted. When “comprise,” “have,” and “include” described in the present disclosure are used, another part can be added unless “only” is used. The terms of a singular form can include plural forms unless referred to the contrary.

In construing an element, the element is construed as including an error or tolerance range although there is no explicit description of such an error or tolerance range.

In describing a position relationship, for example, when a position relation between two parts is described as, for example, “on,” “over,” “under,” and “next,” one or more other parts can be disposed between the two parts unless a more limiting term, such as “just” or “direct(ly)” is used.

In describing a time relationship, for example, when the temporal order is described as, for example, “after,” “subsequent,” “next,” and “before,” a case that is not continuous can be included unless a more limiting term, such as “just,” “immediate(ly),” or “direct(ly)” is used.

It will be understood that, although the terms “first,” “second,” etc. can be used herein to describe various elements, these elements should not be limited by these terms. These terms are only used to distinguish one element from another and may not define order of sequence. For example, a first element could be termed a second element, and, similarly, a second element could be termed a first element, without departing from the scope of the present disclosure.

In describing elements of the present disclosure, the terms “first,” “second,” “A,” “B,” “(a),” “(b),” etc. can be used. These terms are intended to identify the corresponding elements from the other elements, and basis, order, or number of the corresponding elements should not be limited by these terms. The expression that an element is “connected,” “coupled,” or “adhered” to another element or layer should be understood the element or layer cannot only be directly connected or adhered to another element or layer, but also be indirectly connected or adhered to another element or layer with one or more intervening elements or layers “disposed,” or “interposed” between the elements or layers, unless otherwise specified.

The term “at least one” should be understood as including any and all combinations of one or more of the associated listed items. For example, the meaning of “at least one of a first item, a second item, and a third item” denotes the combination of all items proposed from two or more of the first item, the second item, and the third item as well as the first item, the second item, or the third item. Also, the term “can” used herein includes all meanings and definitions of the word “may”.

Features of various implementations of the present disclosure can be partially or overall coupled to or combined with each other, and can be variously inter-operated with each other and driven technically as those skilled in the art can sufficiently understand. The implementations of the present disclosure can be carried out independently from each other, or can be carried out together in co-dependent relationship.

Hereinafter, implementations of the present disclosure will be described in detail with reference to the accompanying drawings.

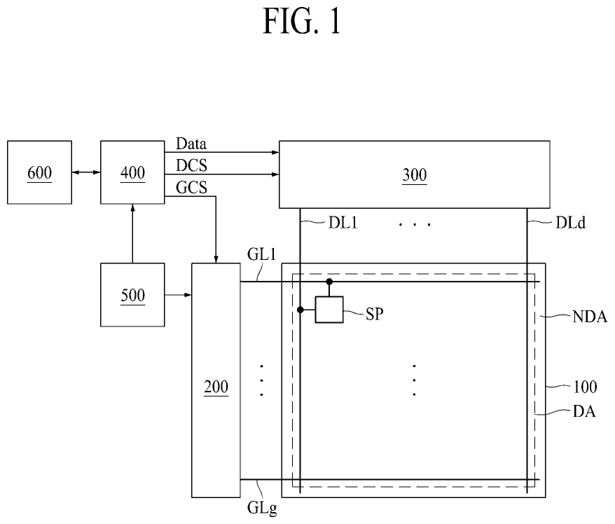

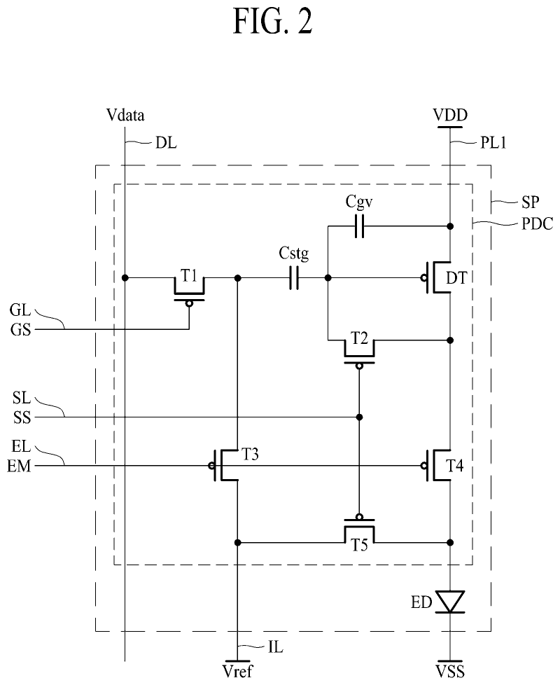

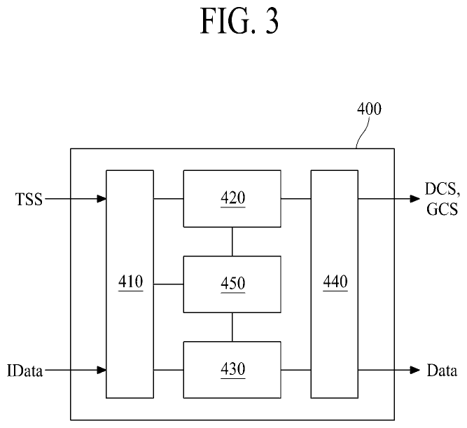

FIG. 1 is an example diagram illustrating a configuration of a light emitting display apparatus according to an implementation of the present disclosure, FIG. 2 is an example diagram illustrating a structure of a sub-pixel applied to a light emitting display apparatus according to an implementation of the present disclosure, and FIG. 3 is an example diagram illustrating a structure of a control circuit applied to a light emitting display apparatus according to an implementation of the present disclosure.

A light emitting display apparatus according to an implementation of the present disclosure can be used as various kinds of electronic devices. Electronic devices can be, for example, televisions, monitors, etc.

A light emitting display apparatus according to an implementation of the present disclosure, as illustrated in FIGS. 1 and 2, can include a light emitting display panel 100 which includes a display area DA displaying an image and a non-display area NDA provided outside the display area DA, a gate driving circuit 200 which supplies gate signals GS to a plurality of gate lines GL1 to GLg provided in the display area DA of the light emitting display panel 100, a data driving circuit 300 which supplies data voltages Vdata to a plurality of data lines DL1 to DLd provided in the display area DA of the light emitting display panel 100, a control circuit 400 which controls driving of the gate driving circuit 200 and the data driving circuit 300, and a power supply circuit 500 which supplies power to the control circuit 400, the gate driving circuit 200, the data driving circuit 300, and the light emitting display panel 100.

First, the light emitting display panel 100 can include a display area DA and a non-display area NDA. Gate lines GL1 to GLg, data lines DL1 to DLd, and sub-pixels SP can be provided in the display area DA. Accordingly, an image can be displayed in the display area DA. Here, g and d are natural numbers. The non-display area NDA can surround the outer periphery of the display area DA.

As shown in FIG. 2, the sub-pixel SP provided in the light emitting display panel 100 can include a first transistor T1, a second transistor T2, a third transistor T3, a fourth transistor T4, a fifth transistor T5, a driving transistor DT, a storage capacitor Cstg, an auxiliary capacitor Cgv, and a light emitting device ED. In this case, a pixel driving circuit PDC can include the first transistor T1, the second transistor T2, the third transistor T3, the fourth transistor T4, the fifth transistor T5, the driving transistor DT, the storage capacitor Cstg, and the auxiliary capacitor Cgv, and the light emitting device ED can be connected to the pixel driving circuit PDC.

For example, the first transistor T1 can include a first terminal connected to a data line DL, a gate connected to a gate line DL, and a second terminal connected to a first terminal of the third transistor T3.

The second transistor T2 can include a gate connected to a scan line SL, a first terminal connected to a gate of the driving transistor DT, and a second terminal connected to a second terminal of the driving transistor DT.

The driving transistor DT can include a first terminal connected to a first power line PL1, a gate connected to a first terminal of the second transistor T2, and a second terminal connected to a second terminal of the second transistor T2.

The storage capacitor Cstg can be connected between the second terminal of the first transistor T1 and the gate of the driving transistor DT. For example, the storage capacitor Cstg can include a first terminal connected to the second terminal of the first transistor T1 and a second terminal connected to the gate of the driving transistor DT.

The third transistor T3 can include a gate connected to an emission line EL, a first terminal connected to the second terminal of the first transistor T1, and a second terminal connected to an initialization line IL to which an initialization voltage Vref is supplied. In this case, the emission line EL can be provided in parallel with the gate line GL and the scan line SL.

The fourth transistor T4 can include a gate connected to an emission line EL, a first terminal connected to the second terminal of the driving transistor DT, and a second terminal connected to the light emitting device ED. In this case, the emission line EL can be connected to the gate of the third transistor T3 and the gate of the fourth transistor T4. In the following description, the fourth transistor T4 can be referred to as an emission transistor.

The fifth transistor T5 can include a gate connected to a scan line SL, a first terminal connected to an initialization line IL, and a second terminal connected to the light emitting device ED. In this case, the scan line SL can be connected to the gate of the fifth transistor T5 and the gate of the second transistor T2.

The auxiliary capacitor Cgv can include a first terminal connected to the gate of the driving transistor DT and a second terminal connected to the first terminal of the driving transistor DT.

In this case, the first to fifth transistors T1 to T5 and the driving transistor DT can be formed of a P-type transistor, as shown in FIG. 2.

A sub-pixel SP applied to a light emitting display apparatus according to an implementation of the present disclosure can include a gate line GL, a scan line SL, and an emission line EL as described above. However, the light emitting display apparatus according to an implementation of the present disclosure is not limited thereto. Accordingly, the light emitting display panel 100 can further include at least one line in addition to the lines described above. Also, the structure of the sub-pixel SP applied to the light emitting display apparatus according to an implementation of the present disclosure is not limited to the structure shown in FIG. 2. Accordingly, the structure of the sub-pixel SP applied to the light emitting display apparatus according to an implementation of the present disclosure can be changed into various forms.

Hereinafter, for convenience of description, a light emitting display apparatus according to an implementation of the present disclosure is described with reference to a sub-pixel SP having the structure shown in FIG. 2

Next, the control circuit 400 can realign input data signal IData transmitted from the external system 600 by using a timing synchronization signal TSS transmitted from the external system 600 and can generate a data control signal DCS which is to be supplied to the data driving circuit 300 and a gate control signal GCS which is to be supplied to the gate driving circuit 200.

To this end, as illustrated in FIG. 3, the control circuit 400 can include a data aligner 430 which realigns input data signal IData to generate data signal Data, a control signal generator 420 which generates the gate control signal GCS and the data control signal DCS by using the timing synchronization signal TSS, an input circuit 410 which transmits the timing synchronization signal TSS transmitted from the external system 600 to the control signal generator 420 and transmits the input data signal IData transmitted from the external system 600 to the data aligner 430, and an output circuit 440 which supplies the data driving circuit 300 with the data signal Data generated by the data aligner 430 and the data control signal DCS generated by the control signal generator 420 and supplies the gate driving circuit 200 with the gate control signal GCS generated by the control signal generator 420.

The control circuit 400 can further include a storage circuit for storing various information. The storage circuit 450 can be included in the control circuit 400 as illustrated in FIG. 3 but can be separated from the control circuit 400 and provided independently.

Next, the external system 600 can perform a function of driving the control driving circuit 400 and an electronic device.

For example, when the electronic device is a television (TV), the external system 600 can receive various kinds of sound information and image information over a communication network and can transmit the received image information to the control circuit 400. For example, the external system 600 can convert the image information into input data signal IData and transmit the input data signal IData to the control circuit 400.

The external system 600 can control various functions of the electronic device by using touch coordinates transmitted from a touch control circuit.

The power supply circuit 500 can generate various powers and supply the generated powers to the control circuit 400, the gate driving circuit 200, the data driving circuit 300, and the light emitting display panel 100. For example, although FIG. 1 shows that the power supply circuit 500 is connected only to the control circuit 400 and the gate driving circuit 200, the power supply circuit 500 can supply power to various components included in the light emitting display apparatus.

Next, the gate driving circuit 200 can be embedded into the non-display area NDA by using a gate-in panel (GIP) type.

The gate driving circuit 200 can supply gate pulses to the gate lines GL1 to GLg.

For example, when a gate pulse generated by the gate driving circuit 200 is supplied to a gate of the first transistor T1 included in the sub-pixel SP illustrated in FIG. 2, the first transistor T1 can be turned on. When the first transistor T1 is turned on, data voltage Vdata supplied through a data line DL can be supplied to the sub-pixel SP.

When a gate-off signal generated by the gate driving circuit 200 is supplied to the first transistor T1, the first transistor T1 can be turned off. When the first transistor T1 is turned off, a data voltage cannot be supplied to the sub-pixel SP any longer.

The gate signal GS supplied to the gate line GL can include the gate pulse and the gate-off signal.

To supply gate pulses to gate lines GL1 to GLg, the gate driving circuit 200 can include gate stages connected to gate lines GL1 to GLg.

Each of the gate stages can be connected to one gate line GL.

In order to generate gate pulses, a gate start signal and at least one gate clock which are generated by the control signal generator 420 can be transferred to the gate driving circuit 200. For example, the gate start signal and the at least one gate clock can be included in the gate control signal GCS.

One of the gate stages can be driven by a gate start signal to output a gate pulse to a gate line GL. The gate pulse can be generated by a gate clock.

At least one of signals output from a gate stage where a gate pulse is output can be supplied to another gate stage to drive another gate stage. Accordingly, a gate pulse can be output in another gate stage.

For example, the gate stages can be driven sequentially to sequentially supply the gate pulses to the gate lines GL.

The gate driving circuit 200 can supply scan pulses and a scan-off signal to the scan lines SL. The scan pulse means a signal corresponding to the gate pulse, and the scan-off signal means a signal corresponding to the gate-off signal.

Accordingly, the second transistor T2 and the fifth transistor T5 connected to the scan line SL can be turned on by a scan pulse and can be turned off by a scan-off signal.

The scan signal SS supplied to the scan line SL can include a scan pulse and a scan-off signal.

To supply scan pulses to the scan lines SL, the gate driving circuit 200 can include scan stages connected to the scan lines SL.

Scan stages can be driven in the same or similar manner as gate stages.

The gate driving circuit 200 can supply emission pulses and emission-off signals to the emission lines EL. The emission pulse means a signal corresponding to a gate pulse, and the emission-off signal means a signal corresponding to a gate-off signal.

Therefore, the third transistor T3 and the fourth transistor T4 connected to the emission line EL can be turned on by an emission pulse and can be turned off by an emission off signal.

The emission signal EM supplied to the emission line EL can include an emission pulse and an emission off signal.

To supply the emission pulses to the emission lines EL, the gate driving circuit 200 can include emission stages connected to the emission lines EL.

The emission stages can be driven in the same or similar manner as the gate stages.

As described above, the gate driving circuit 200 can be provided in the non-display area NDA of the light emitting display panel 100. The gate driving circuit 200 can supply the gate signal GS to the gate line GL, the scan signal SS to the scan line SL, and the emission signal EM to the emission line EL. Each of the gate signal GS, the scan signal SS, and the emission signal EM can be referred to as a driving signal. For example, the gate driving circuit 200 can supply driving signals to the gate line GL, the scan line SL, and the emission line EM provided in the light emitting display panel 100.

Finally, the data driving circuit 300 can supply data voltages Vdata to the data lines DL1 to DLd.

To this end, the data driving circuit 300 can include a shift register which outputs a sampling signal, a latch which latches data signal Data received from the control circuit 400, a digital-to-analog converter which converts the data signal Data transmitted from the latch into a data voltage Vdata and outputs the data voltage Vdata, and an output buffer which outputs the data voltage transmitted from the digital-to-analog converter to the data line DL on the basis of a source output enable signal SOE.

The data voltages Vdata supplied to the data lines DL1 to DLd can be supplied to sub-pixels SP connected to a gate line GL supplied with a gate pulse.

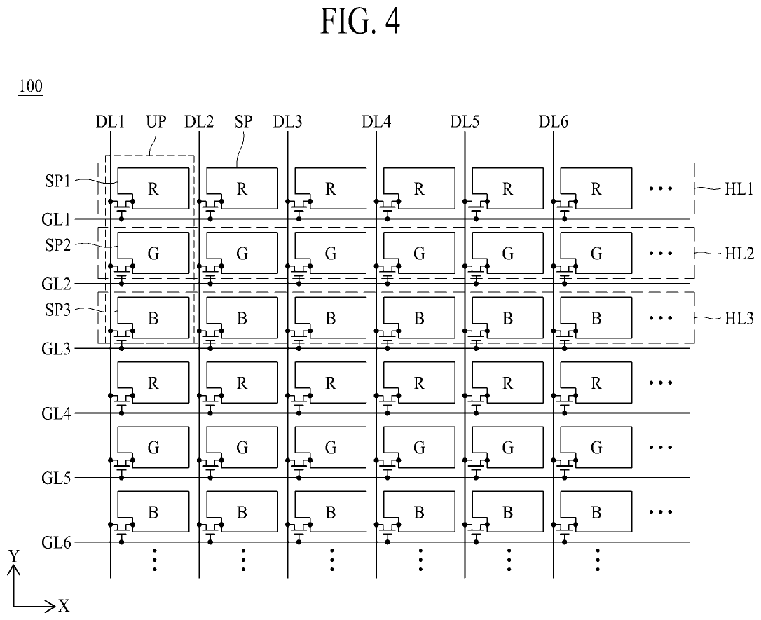

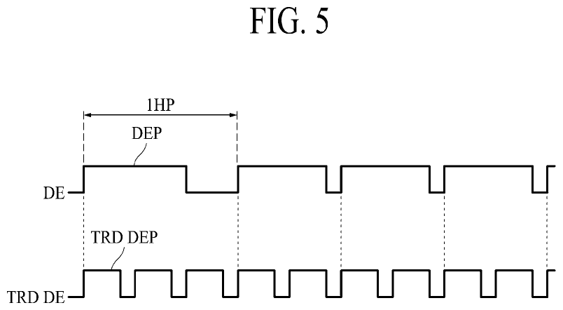

FIG. 4 is an example diagram illustrating a structure of a light emitting display panel applied to a light emitting display apparatus according to an implementation of the present disclosure, and FIG. 5 is a waveform diagram illustrating a TRD data enable signal applied to a light emitting display apparatus according to an implementation of the present disclosure.

In the light emitting display panel 100 according to an implementation of the present disclosure, a gate line GL can be provided along a first direction, and a data line DL can be provided along a second direction different from the first direction. For example, the first direction can be the X-axis direction illustrated in FIG. 4, and the second direction can be the Y-axis direction illustrated in FIG. 4. Accordingly, in the following description, a reference numeral X is assigned to the first direction and a reference numeral Y is assigned to the second direction.

In addition, each of the gate lines GL can extend along the first direction X, and each of the data lines DL can extend along the second direction Y.

Also, the scan lines SL and the emission lines EM can be provided in parallel with the gate line GL.

Accordingly, each of the scan lines SL can extend along the first direction X, and each of the emission lines EM can extend along the first direction X.

In this case, sub-pixels SP of the same color can be provided along the first direction X.

For example, as shown in FIG. 4, the sub-pixels SP connected to the first gate line GL1 can be provided along the first direction X, and each of the sub-pixels SP connected to the first gate line GL1 can output red light.

Also, each of the sub-pixels SP connected to the second gate line GL2 can output green light.

Also, each of the sub-pixels SP connected to the third gate line GL3 can output blue light.

In this case, the sub-pixels SP provided along the first direction X can form a row HL. For example, in the row HL, the sub-pixels SP provided along the first direction X can be provided, and the row can mean a virtual line formed by the sub-pixels SP provided along the first direction X.

For example, a virtual line formed by sub-pixels SP connected to the first gate line GL1 can be referred to as a first row HL1, a virtual line formed by sub-pixels SP connected to the second gate line GL2 can be referred to as a second row HL2, and a virtual line formed by sub-pixels SP connected to the third gate line GL3 can be referred to as a third row HL3.

The data line DL can be connected to a first sub-pixel SP1 provided in the first row HL1, a second sub-pixel SP2 provided in the second row HL2 adjacent to the first row HL1, and a third sub-pixel SP3 provided in the third row HL3 adjacent to the second row HL2.

In this case, a first color of the first sub-pixel SP1, a second color of the second sub-pixel SP, and a third color of the third sub-pixel SP3 can be different from each other.

For example, in the example shown in FIG. 4, the first color of the first sub-pixel SP1 can be red R, the second color of the second sub-pixel SP2 can be green G, and the third color of the third sub-pixel SP3 can be blue B.

In this case, the first sub-pixel SP1, the second sub-pixel SP2, and the third sub-pixel SP3 can form a unit pixel UP that outputs white light.

As illustrated in FIG. 4, the above-described structure can be continuously formed in the light emitting display panel 100.

Compared to a light emitting display panel (hereinafter simply referred to as an “alternative light emitting display panel”) that includes sub-pixels of different colors along a gate line and has the same resolution as the light emitting display panel shown in FIG. 4, the number of data lines can be reduced by ⅓ in a light emitting display panel 100 with a structure described with reference to FIG. 4.

For example, in a light emitting display panel in which sub-pixels of different colors are provided along a gate line, unit pixels can be provided along the gate line, and three sub-pixels can be provided in each of the unit pixels. Therefore, three data lines must be provided to drive the three sub-pixels provided in the unit pixel.

However, in the light emitting display panel 100 as shown in FIG. 4, three sub-pixels SP constituting the unit pixel UP can be provided along one data line DL, and thus the unit pixel UP can be driven by one data line DL.

Therefore, the number of data lines DL can be reduced by ⅓ according to the light emitting display panel 100 having a structure as shown in FIG. 4 compared to the alternative light emitting display panel.

In this case, the driving frequency of a data enable signal applied to the light emitting display panel 100 having the structure shown in FIG. 4 can be three times greater than the driving frequency of a data enable signal applied to the alternative light emitting display panel.

Therefore, the light emitting display panel 100 shown in FIG. 4 can be referred to as a triple rate driving (TRD) panel.

In the following description, a data enable signal applied to the light emitting display panel 100 according to an implementation of the present disclosure is referred to as a TRD data enable signal.

Each of the data enable signal and the TRD data enable signal can be a signal for controlling a timing of outputting the data voltage Vdata to a data line DL.

For example, as illustrated in FIG. 5, in a light emitting display apparatus to which the alternative light emitting display panel is applied, one data enable pulse DEP can be transmitted to the data driving circuit in one horizontal period 1HP. Thus, while the gate pulse is supplied to one gate line, the data voltages can be supplied to the pixels through the data lines. Thus, light can be simultaneously output through three sub-pixels connected to one gate line and constituting a unit pixel.

However, in a light emitting display panel to which the light emitting display panel according to an implementation of the present disclosure is applied, three sub-pixels SP constituting the unit pixel UP are connected to three gate lines. Therefore, in order to output light through the three sub-pixels SP constituting the unit pixel UP, three data voltages Vdata must be sequentially supplied to a data line DL.

To this end, as illustrated in FIG. 5, in a light emitting display apparatus to which a light emitting display panel according to an implementation of the present disclosure is applied, three TRD data enable pulses TRD DEP have to be transmitted to the data driving circuit 300 or generated by the data driving circuit 300 in one horizontal period (1HP).

Therefore, the driving frequency of the TRD data enable signal TRD DE applied to the light emitting display panel 100 having the structure shown in FIG. 4 should be three times higher than the driving frequency of the data enable signal DE applied to the alternative light emitting display panel.

In addition, in the alternative light emitting display panel, three sub-pixels SP constituting the unit pixel UP are provided along one gate line. Therefore, in the alternative light emitting display panel to which the sub-pixel SP as shown in FIG. 2 is applied, three stages can be provided in one row to drive the unit pixel.

However, in the light emitting display panel shown in FIG. 4, three sub-pixels SP constituting the unit pixel UP are provided along the three gate lines GL. Therefore, when the sub-pixel SP shown in FIG. 2 is applied to the light emitting display panel shown in FIG. 4, nine stages must be provided in three rows HL to drive the unit pixel UP.

For example, in order to drive the sub-pixel SP shown in FIG. 2, one gate stage, one scan stage, and one emission stage have to be provided as described above. Therefore, in order to drive the three sub-pixels SP connected to the three gate lines and forming the unit pixel UP, three gate stages, three scan stages, and three emission stages have to be provided.

In other words, compared to the alternative light emitting display panel, the light emitting display panel 100 applied to an implementation of the present disclosure should have three times the stages in the non-display area NDA, and thus the non-display area NDA have to be increased.

To solve this problem, the light emitting display apparatus according to an implementation of the present disclosure can drive three sub-pixels SP constituting the unit pixel UP by using three gate stages, one scan stage, and one emission stage.

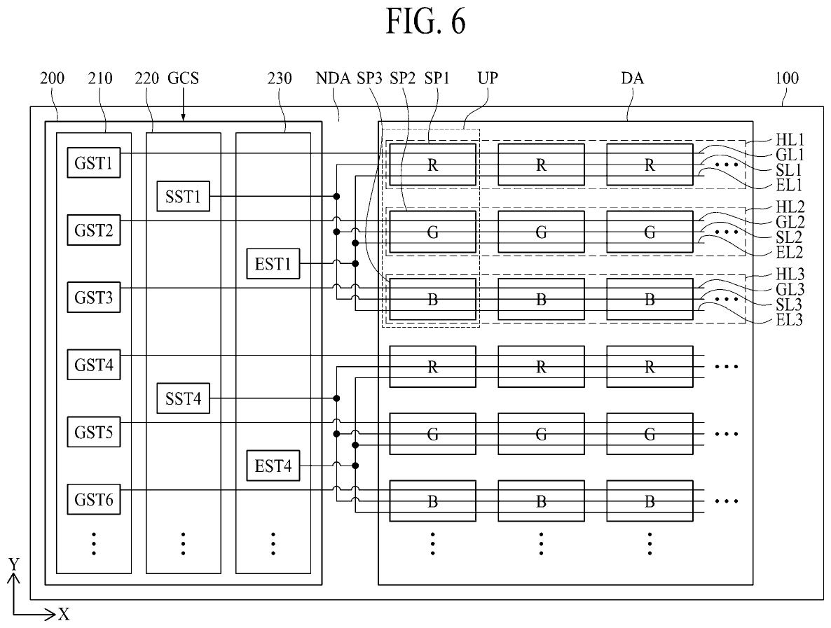

This will be described in detail below with reference to FIG. 6.

FIG. 6 is an example diagram illustrating structures of a light emitting display panel and a gate driving circuit applied to a light emitting display apparatus according to an implementation of the present disclosure. In the following descriptions, contents that are the same as or similar to those described with reference to FIGS. 1 to 5 will be omitted or briefly described.

In the light emitting display panel 100 applied to the light emitting display apparatus according to an implementation of the present disclosure, the gate driving circuit 200 is provided in the non-display area NDA of the light emitting display panel 100.

The gate line GL, the scan line SL, and the emission line EL extend along the first direction X, and the data line DL extends along the second direction Y.

In this case, as shown in FIG. 2, the gate line GL can mean a line connected to the gate of the first transistor T1, the scan line SL can mean a line connected to the gates of the second transistor T2 and the fifth transistor T5, and the emission line EL can mean a line connected to the gates of the third transistor T3 and the fourth transistor T4.

The sub-pixels SP provided along the first direction X output light of the same color, and the sub-pixels SP provided along the first direction X form a row HL. That is, the row HL can be provided along the first direction X, and the sub-pixels SP can be provided in the row HL.

A first gate line GL1, a first scan line SL1, and a first emission line EL1 can be provided in a first row HL1, a second gate line GL2, a second scan line SL2, and a second emission line EL2 can be provided in a second row HL2, and a third gate line GL3, a third scan line SL3, and a third emission line EL3 can be provided in a third row HL3.

Accordingly, a first sub-pixel SP1 provided in the first row HL1 can be connected to a first gate line GL1, a first scan line SL1, and a first emission line EL1, a second sub-pixel SP2 provided in the second row HL2 can be connected to a second gate line GL2, a second scan line SL2, and a second emission line EL2, and a third sub-pixel SP3 provided in the third row HL3 can be connected to a third gate line GL3, a third scan line SL3, and a third emission line EL3.

In this case, the first scan line SL1 can be connected to at least one scan line SL provided in at least one row HL adjacent to the first row HL1.

For example, the first scan line SL1 can be connected to the second scan line SL2 provided in the second row HL2 adjacent to the first row HL1 and the third scan line SL3 provided in the third row HL3 adjacent to the second row HL2.

As described above, a scan signal SS capable of turning on the second transistor T2 can be supplied to the first scan line SL1, and an initialization voltage Vref for initializing the gate of the driving transistor DT provided in the sub-pixel SP can be supplied through the second transistor T2.

In addition, the first emission line EL1 provided in the first row HL1 can be connected to at least one emission line EL provided in at least one row HL adjacent to the first row HL1.

For example, the first emission line EL1 can be connected to the second emission line EL2 provided in the second row HL2 adjacent to the first row HL1 and the third emission line EL3 provided in the third row HL3 adjacent to the second row HL2.

As described above, the first emission line EL1 can be connected to a gate of the fourth transistor (emission transistor) T4 connected between the driving transistor DT and the light emitting device ED provided in the sub-pixel SP. An emission signal EM can be supplied to the first emission line EL1.

When the fourth transistor T4 is turned on by the emission signal EM, a current can flow to the light emitting device ED through the driving transistor DT and the fourth transistor T4, and accordingly, light can be output from the light emitting device ED.

The gate driving circuit 200 provided in the non-display area NDA of the light emitting display panel 100 can include a first gate stage GST1 connected to the first gate line GL1, a first scan stage SST connected to the first scan line SL1, and a first emission stage EST1 connected to the first emission line EL1.

The gate driving circuit 200 can include a gate stage circuit 210 including the first gate stage GST1, a scan stage circuit 220 including the first scan stage SST1, and an emission stage circuit 230 including the first emission stage EST1.

In this case, the first gate stage GST1 can be connected only to the first gate line GL1. That is, each of the gate lines GLs can be connected to one gate stage GST1 in a one-to-one manner.

Accordingly, the gate stage circuit 210 can include a first gate stage GST1 connected to the first gate line GL1 provided in the first row HL1, a second gate stage GST2 connected to the second gate line GL2 provided in the second row HL2, and a third gate stage GST3 connected to the third gate line GL3 provided in the third row HL3.

However, the first scan stage SST1 can be connected to a second scan line SL2 provided in the second row HL2 adjacent to the first row HL1 and a third scan line SL3 provided in the third row HL3 adjacent to the second row HL2.

Therefore, the scan stage circuit 220 does not need to be provided with a second scan stage for supplying the scan signal SS to the second scan line SL2 and a third scan stage for supplying the scan signal SS to the third scan line SL3.

In addition, the first emission stage EST1 can be connected to a second emission line EL2 provided in the second row HL2 and a third emission line EL3 provided in the third row HL3.

Therefore, the emission stage circuit 230 does not need to be provided with a second emission stage for supplying the emission signal EM to the second emission line EL2 and a third emission stage for supplying the emission signal EM to the third emission line EL3.

Accordingly, five stages GST1 to GST3, SST1, and EST1 can be provided in the gate driving circuit 200 to supply driving signals to the three gate lines GL1 to GL3, the three scan lines SL1 to SL3, and the three emission lines EL1 to EL3 provided in the three rows HL1 to HL3.

Therefore, in the non-display area NDA of the light emitting display panel 100, a number of stages GST1 to GST3, SST1, and EST1 smaller than the number of gate lines GL1 to GL3, scan lines SL1 to SL3, and emission lines EL1 to EL3 provided in the three rows HL1 to HL3 can be provided, and thus the non-display area NDA can be reduced compared to the alternative light emitting display panel.

In this case, the first sub-pixel SP1 provided in the first row HL1, the second sub-pixel SP2 provided in the second row HL2, and the third sub-pixel SP3 provided in the third row HL3 can be connected to the first gate stage GST1, the second gate stage GST2, the third gate stage GST3, the first scan stage SST1, and the first emission stage EST1.

When the first sub-pixel SP1, the second sub-pixel SP2, and the third sub-pixel SP3 are adjacent along the data line DL, the first sub-pixel SP1, the second sub-pixel SP2, and the third sub-pixel SP3 can form a unit pixel UP that outputs white light.

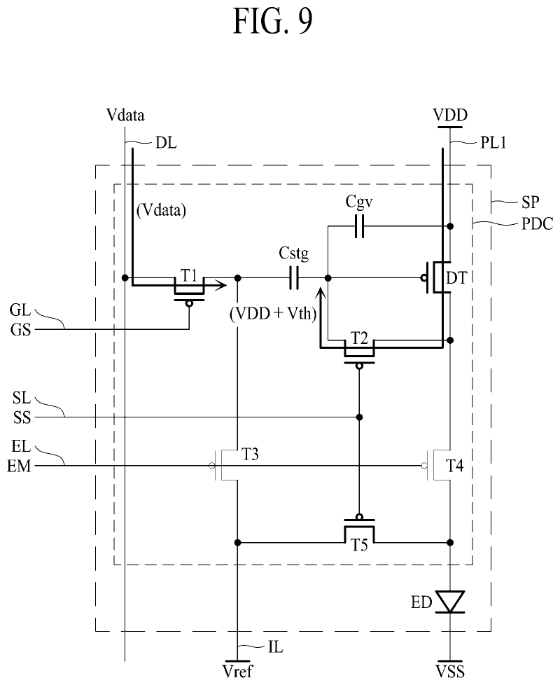

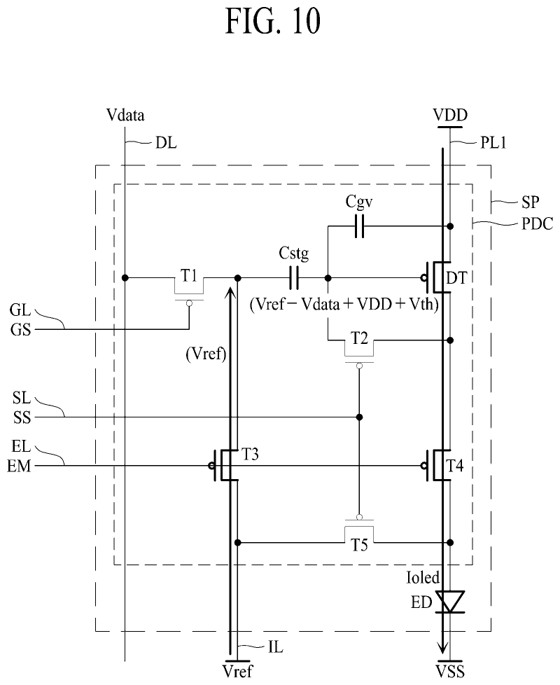

Hereinafter, a method of driving a light emitting display apparatus according to an implementation of the present disclosure will be described in detail with reference to FIGS. 1 to 10.

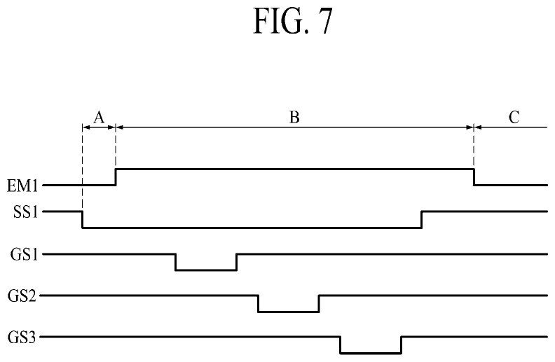

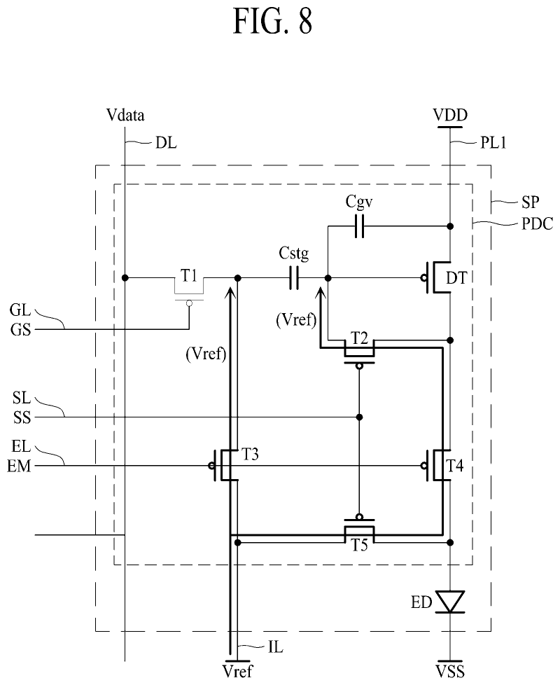

FIG. 7 is waveform diagrams of signals applied to a light emitting display apparatus according to an implementation of the present disclosure, and FIGS. 8 to 10 are example diagrams illustrating driving methods of a pixel driving circuit applied to a light emitting display apparatus according to an implementation of the present disclosure.

First of all, the characteristics of the light emitting display apparatus according to an implementation of the present disclosure described above with reference to FIGS. 1 to 6 are briefly summarized as follows.

The gate stage circuit 210 can include the first gate stage GST1 connected to the first gate line GL1 in the first row HL1, a second gate stage GST2 connected to the second gate line GL2 in the second row HL2, and a third gate stage GST3 connected to the third gate line GL3 in the third row HL3. For example, the gate stage GST and the gate line GL can be connected in a one-to-one manner.

However, the scan stage circuit 220 can include the first scan stage SST1 connected to the first scan line SL1, and the first scan stage SST1 can be connected to the second scan line SL2 and the third scan line SL3. Accordingly, the scan stage circuit 220 does not need to be provided with a second scan stage for supplying the scan signal SS to the second scan line SL2 and a third scan stage for supplying the scan signal SS to the third scan line SL3.

In addition, the emission stage circuit 230 can include the first emission stage EST1 connected to the first emission line EL1, and the first emission stage EST1 can be connected to the second emission line EL2 and the third emission line EL3. Accordingly, the emission stage circuit 230 does not need to be provided with a second emission stage for supplying the emission signal EM to the second emission line EL2 and a third emission stage for supplying the emission signal EM to the third emission line EL3.

Therefore, the number of stages provided in the non-display area NDA can be reduced, and accordingly, the size of the non-display area NDA can be reduced.

In this case, when each of the sub-pixels SP includes a pixel driving circuit PDC having the structure shown in FIG. 2, the light emitting display apparatus can be driven as follows.

First, as shown in FIGS. 6 and 7, gates of the driving transistors DT provided in the first sub-pixel SP1 connected to the first scan line SL1, the second sub-pixel SP2 connected to the second scan line SL2, and the third sub-pixel SP3 connected to the third scan line SL3 can be initialized by the initialization voltage Vref during the initialization period A in which the first scan signal SS1 of the first level is supplied to the first scan line SL1 and the first emission signal EM1 of the first level is supplied to the first emission line EL1.

Here, the first level means a high level or a low level, and in the example shown in FIG. 7, the first level can be a low level. Therefore, in the following description, the first level can mean a low level.

Gate signals GS1, GS2, and GS3 having a second level opposite to the first level can be supplied to the first gate line GL1, the second gate line GL2, and the third gate line GL3 during the initialization period A.

Here, the second level means a low level or a high level, and in the example shown in FIG. 7, the second level can be a high level. Therefore, in the following description, the second level can mean a high level.

For example, because the transistors provided in the pixel circuit PDC shown in FIG. 2 are P-type transistors, the third transistor T3 and the fourth transistor T4 can be turned on by the first emission signal EM1 of the first level, the second transistor T2 and the fifth transistor T5 can be turned on by the first scan signal SS1 of the first level, and the first transistors T1 can be turned off by the gate signals GS1, GS2, and GS3 of the second level.

Therefore, as shown in FIG. 8, the initialization voltage Vref can be supplied to the gate of the driving transistor DT through the fifth transistor T5, the fourth transistor T4, and the second transistor T2, and accordingly, the voltage of the gate of the driving transistor DT can be the initialization voltage Vref.

In this case, each of the voltage of the first terminal and the voltage of the second terminal of the storage capacitor Cst can be an initialization voltage Vref.

Second, as shown in FIGS. 6 and 7, gate signals GS1, GS2, and GS3 of the first level can be sequentially supplied to the first gate line GL1, the second gate line GL2, and the third gate lien GL3 during a writing period B in which the first scan signal SS1 of the first level of is supplied to the first scan line SL1 and the first emission signal EM1 of the second level opposite to the first level is supplied to the first emission line EL1.

Accordingly, the data voltages Vdata can be sequentially supplied to the first terminals of the storage capacitor Cst of the sub-pixels SP connected to the first gate line GL1, the second gate line GL2, and the third gate line GL3.

For example, because the transistors provided in the pixel circuit PDC shown in FIG. 2 are P-type transistors, the third transistor T3 and the fourth transistor T4 can be turned off by the first emission signal EM1 of the second level, the second transistor T2 and the fifth transistor T5 can be turned on by the first scan signal SS1 of the first level, and the first transistors T1 can be sequentially turned on by the gate signals GS1, GS2, and GS3 of the first level.

Thus, as shown in FIG. 8, the data voltage Vdata supplied through the data line DL can be supplied to the first terminal of the storage capacitor Cst, and the first voltage VDD and the threshold voltage Vth of the driving transistor can be applied to the gate of the driving transistor DT through the first power line PL1, the driving transistor DT, and the second transistor T2.

Third, as shown in FIGS. 6 and 7, light can be output from sub-pixels provided in the first row HL1, the second row HL2, and the third row HL3 during the first scan signal SS1 of the second level opposite to the first level is supplied to the first scan line SL1, the first emission signal EM1 of the first level is supplied to the first emission line EL1, and the gate signals GS1, GS2, and GS3 of the second level is supplied to the first gate line GL1, the second gate line, and the third gate line GL3.

For example, because the transistors provided in the pixel circuit PDC shown in FIG. 2 are P-type transistors, the third transistor T3 and the fourth transistor T4 can be turned on by the first emission signal EM1 of the first level, the second transistor T2 and the fifth transistor T5 can be turned off by the first scan signal SS1 of the second level, and the first transistors T1 can be turned off by the gate signals GS1, GS2, and GS3 of the second level.

Therefore, in the emission period C, as shown in FIG. 8, current Iold can be supplied to the light emitting device ED through the driving transistor DT and the fourth transistor T4, and accordingly, light can be output from the light emitting device ED.

In addition, in the emission period C, the initialization voltage Vref can be supplied to the first terminal of the storage capacitor Cst through the third transistor T3, the gate voltage Vg of Equation 1 can be applied to the gate of the driving transistor DT, and the source voltage Vs of the driving transistor DT can be the first voltage VDD.

Vg=Vref−Vdata+VDD+Vth Equation 1

The current Iold flowing to the light emitting device ED during the emission period C can be expressed as Equation 2.

Ioled=k(Vgs−Vth)² Equation 2

In Equation 2, the gate-source voltage Vgs means a voltage obtained by subtracting the source voltage Vs of the driving transistor DT from the gate voltage Vg of the driving transistor DT, and Vth means the threshold voltage of the driving transistor DT.

In Equation 2, k can be a constant considering the mobility of the driving transistor DT, the width of the channel, the length of the channel, and the like.

In the example described with reference to FIGS. 6 to 10, the gate-source voltage Vgs of the driving transistor DT can be expressed as Equation 3.

Vgs=(Vref−Vdata+VDD+Vth)−VDD=Vref−Vdata+Vth Equation 3

Therefore, a voltage obtained by subtracting the threshold voltage Vth of the driving transistor DT from the gate source voltage Vgs of the driving transistor DT can be expressed as Equation 4.

Vgs−Vth=(Vref−Vdata+Vth)−Vth=Vref−Vdata Equation 4

Accordingly, according to Equation 1 to Equation 4, the current Ioled flowing to the light emitting device ED during the emission period C can be proportional to the square of the difference voltage between the initialization voltage Vref and the data voltage Vdata.

Therefore, according to the light emitting display apparatus according to an implementation of the present disclosure, the magnitude of the current Ioled flowing to the light emitting device ED is not related to the threshold voltage Vth of the driving transistor DT and can be determined by the initialization voltage Vref and the data voltage Vdata.

The luminance of light output from the light emitting device ED can be determined by the magnitude of the current Ioled flowing to the light emitting device ED.

Therefore, even if the driving transistor DT is deteriorated due to the long use of the light emitting display apparatus according to an implementation of the present disclosure, the luminance of light output from the light emitting device ED can be changed only by the initialization voltage Vref and the data voltage Vdata, and is not affected by the threshold voltage Vth of the driving transistor DT.

Therefore, according to the light emitting display apparatus according to an implementation of the present disclosure, the quality of the light emitting display apparatus can be maintained for a long time.

The features of the light emitting display apparatus according to an implementation of the present disclosure are briefly summarized as follows.

A light emitting display apparatus according to an implementation of the present disclosure comprises a light emitting display panel in which a first gate line and a first scan line extend along a first direction, and a data line extend along a second direction different from the first direction and a gate driving circuit provided in a non-display area of the light emitting display panel and supplying driving signals to the first gate line and the first scan line, wherein sub-pixels that output light of the same color are provided in a first row along the first direction, the sub-pixels provided along the first direction are connected to the first gate line and the first scan line, and the first scan line is connected to a second scan line provided in a second row adjacent to the first row.

An initialization voltage for initializing a gate of a driving transistor is supplied through a transistor turned on by a scan signal applied through the first scan line.

The first scan line is further connected to a third scan line provided in a third row adjacent to the second row.

A light emitting display apparatus according to an implementation of the present disclosure further comprises a first emission line provided in the first row, wherein the first emission line is connected to a second emission line provided in the second row.

The first emission line is connected to a gate of an emission transistor connected between a driving transistor and a light emitting device which are provided in a sub-pixel.

The first emission line is further connected to a third emission line provided in a third row adjacent to the second row.

The data line is connected to a first sub-pixel provided in the first row, a second sub-pixel provided in the second row, and a third sub-pixel provided in a third row adjacent to the second row, and a first color of the first sub-pixel, a second color of the second sub-pixel, and a third color of the third sub-pixel are different from each other.

The first sub-pixel, the second sub-pixel, and the third sub-pixel form a unit pixel that outputs white light.

Each of the sub-pixels includes a first transistor including a first terminal connected to a data line and a gate connected to the first gate line, a second transistor including a gate connected to the first scan line, a driving transistor including a first terminal connected to a first power line, a gate connected to a first terminal of the second transistor, and a second terminal connected to a second terminal of the second transistor, a storage capacitor connected between a second terminal of the first transistor and the gate of the driving transistor, a third transistor including a gate connected to a first emission line provided in parallel with the first gate line and the first scan line, a first terminal connected to the second terminal of the first transistor, and a second terminal connected to an initialization line to which an initialization voltage is supplied, a fourth transistor including a gate connected to the first emission line, a first terminal connected to the second terminal of the driving transistor, and a second terminal connected to a light emitting device, and a fifth transistor including a gate connected to the first scan line, a first terminal connected to the initialization line, and a second terminal connected to the light emitting device.

The gate driving circuit includes a first gate stage connected to the first gate line, a first scan stage connected to the first scan line, and a first emission stage connected to a first emission line provided in the first row, and the first scan stage is connected to a second scan line provided in the second row and a third scan line provided in a third row adjacent to the second row.

The gate driving circuit further includes a second gate stage connected to a second gate line provided in the second row above and a third gate stage connected to a third gate line provided in the third row.

The first emission stage is connected to a second emission line provided in the second row and a third emission line provided in the third row.

A first sub-pixel provided in the first row, a second sub-pixel provided in the second row, and a third sub-pixel provided in the third row are connected to the first gate stage, the second gate stage, the third gate stage, the first scan stage, and the first emission stage.

The first sub-pixel, the second sub-pixel, and the third sub-pixel are adjacent along a data line and form a unit pixel that outputs white light.

In an initialization period during which a first scan signal of a first level is supplied to the first scan line and a first emission signal of the first level is supplied to the first emission line, gates of driving transistors provided in a first sub-pixel connected to the first scan line, a second sub-pixel connected to the second scan line, and a third sub-pixel connected to the third scan line are initialized by an initialization voltage.

In a writing period during which a first scan signal of a first level is supplied to the first scan line and a first emission signal of a second level opposite to the first level is supplied to the first emission line, gate signals of the first level are sequentially supplied to the first gate line, the second gate line, and the third gate line.

In an emission period during which a first scan signal of a second level opposite to the first level is supplied to the first scan line, a first emission signal of the first level is supplied to the first emission line, and gate signals of the second level are supplied to the first gate line, the second gate line, and the third gate line, light is output from sub-pixels provided in the first row, the second row, and the third row.

The light emitting display apparatus according to an implementation of the present disclosure can be applied to all electronic devices requiring a display of an image. For example, the light emitting display apparatus according to an implementation of the present disclosure can be applied to a virtual reality (VR) device, an augmented reality (AR) device, a mobile device, a video phone, a smart watch, a watch phone, or a wearable device, foldable device, rollable device, bendable device, flexible device, curved device, electronic notebook, e-book, PMP (portable multimedia player), PDA (personal digital assistant), MP3 player, mobile medical device, desktop PC, laptop PC, netbook computer, workstation, navigation, car navigation, vehicle display devices, televisions, wall paper display devices, signage devices, game devices, laptops, monitors, cameras, camcorders, and home appliances.

According to the light emitting display apparatus according to an implementation of the present disclosure, the number of data driving circuits can be reduced without sacrificing resolution, thereby reducing the manufacturing cost and simplifying the manufacturing process of the light emitting display apparatus.

According to the light emitting display apparatus according to an implementation of the present disclosure, the number of stages corresponding to a unit pixel can be reduced without degrading resolution. Accordingly, a light emitting display panel with a reduced non-display area can be provided.

The above-described feature, structure, and effect of the present disclosure are included in at least one implementation of the present disclosure, but are not limited to only one implementation. Furthermore, the feature, structure, and effect described in at least one implementation of the present disclosure can be implemented through combination or modification of other implementations by those skilled in the art. Therefore, content associated with the combination and modification should be construed as being within the scope of the present disclosure.

It will be apparent to those skilled in the art that various modifications and variations can be made in the present disclosure without departing from the spirit or scope of the disclosures. Thus, it is intended that the present disclosure covers the modifications and variations of this disclosure provided they come within the scope of the present disclosure.

What is claimed is:

1. A light emitting display apparatus comprising:
a light emitting display panel in which a first gate line and a first scan line extend along a first direction, and a data line extends along a second direction different from the first direction; and
a gate driving circuit provided in a non-display area of the light emitting display panel and configured to supply driving signals to the first gate line and the first scan line,
wherein sub-pixels that output light of a same color are arranged in a first row along the first direction,
wherein the sub-pixels provided along the first direction are connected to the first gate line and the first scan line, and
wherein the first scan line is connected to a second scan line arranged in a second row adjacent to the first row.

2. The light emitting display apparatus of claim 1, wherein
an initialization voltage for initializing a gate of a driving transistor is supplied through a transistor turned on by a scan signal applied through the first scan line.

3. The light emitting display apparatus of claim 1, wherein
the first scan line is further connected to a third scan line provided in a third row adjacent to the second row.

4. The light emitting display apparatus of claim 1, further comprising: a first emission line arranged in the first row,
wherein the first emission line is connected to a second emission line arranged in the second row.

5. The light emitting display apparatus of claim 4, wherein
the first emission line is connected to a gate of an emission transistor connected between a driving transistor and a light emitting device which are provided in a sub-pixel.

6. The light emitting display apparatus of claim 4, wherein
the first emission line is further connected to a third emission line arranged in a third row adjacent to the second row.

7. The light emitting display apparatus of claim 1, wherein
the data line is connected to a first sub-pixel arranged in the first row, a second sub-pixel arranged in the second row, and a third sub-pixel arranged in a third row adjacent to the second row, and
a first color of the first sub-pixel, a second color of the second sub-pixel, and a third color of the third sub-pixel are different from each other.

8. The light emitting display apparatus of claim 7, wherein
the first sub-pixel, the second sub-pixel, and the third sub-pixel are part of a unit pixel that is configured to output white light.

9. The light emitting display apparatus of claim 1, wherein
each of the sub-pixels includes:
a first transistor including (i) a first terminal connected to a data line and (ii) a gate connected to the first gate line;
a second transistor including a gate connected to the first scan line;
a driving transistor including (i) a first terminal connected to a first power line, (ii) a gate connected to a first terminal of the second transistor, and (iii) a second terminal connected to a second terminal of the second transistor;
a storage capacitor connected between a second terminal of the first transistor and the gate of the driving transistor;
a third transistor including (i) a gate connected to a first emission line provided in parallel with the first gate line and the first scan line, (ii) a first terminal connected to the second terminal of the first transistor, and (iii) a second terminal connected to an initialization line to which an initialization voltage is supplied;
a fourth transistor including (i) a gate connected to the first emission line, (ii) a first terminal connected to the second terminal of the driving transistor, and (iii) a second terminal connected to a light emitting device; and
a fifth transistor including (i) a gate connected to the first scan line, (ii) a first terminal connected to the initialization line, and (iii) a second terminal connected to the light emitting device.

10. The light emitting display apparatus of claim 1, wherein
the gate driving circuit includes:
a first gate stage connected to the first gate line;
a first scan stage connected to the first scan line; and
a first emission stage connected to a first emission line arranged in the first row, and
the first scan stage is connected to (i) a second scan line arranged in the second row and (ii) a third scan line arranged in a third row adjacent to the second row.

11. The light emitting display apparatus of claim 10, wherein
the gate driving circuit further includes:
a second gate stage connected to a second gate line arranged in the second row above; and
a third gate stage connected to a third gate line arranged in the third row.

12. The light emitting display apparatus of claim 10, wherein
the first emission stage is connected to (i) a second emission line arranged in the second row and (ii) a third emission line arranged in the third row.

13. The light emitting display apparatus of claim 11, wherein
a first sub-pixel arranged in the first row, a second sub-pixel arranged in the second row, and a third sub-pixel arranged in the third row are connected to the first gate stage, the second gate stage, the third gate stage, the first scan stage, and the first emission stage.

14. The light emitting display apparatus of claim 13, wherein
the first sub-pixel, the second sub-pixel, and the third sub-pixel are adjacent to each other along a data line and are part of a unit pixel that is configured to output white light.

15. The light emitting display apparatus of claim 10, wherein
in an initialization period during which (i) a first scan signal of a first level is supplied to the first scan line and (ii) a first emission signal of the first level is supplied to the first emission line, gates of driving transistors provided in (i) a first sub-pixel connected to the first scan line, (ii) a second sub-pixel connected to the second scan line, and (iii) a third sub-pixel connected to the third scan line are initialized by an initialization voltage.

16. The light emitting display apparatus of claim 11, wherein
in a writing period during which (i) a first scan signal of a first level is supplied to the first scan line and (ii) a first emission signal of a second level opposite to the first level is supplied to the first emission line, gate signals of the first level are sequentially supplied to the first gate line, the second gate line, and the third gate line.

17. The light emitting display apparatus of claim 16, wherein
in an emission period during which (i) a first scan signal of a second level opposite to the first level is supplied to the first scan line, (ii) a first emission signal of the first level is supplied to the first emission line, and (iii) gate signals of the second level are supplied to the first gate line, the second gate line, and the third gate line, light is output from sub-pixels provided in the first row, the second row, and the third row.
